(19) United States
(12) Patent Application Publication
(10) Pub. No.: US 2020/0364687 A1
(43) Pub. Date: Nov. 19, 2020

(54) SETTLEMENT SYSTEM INCLUDING USER MANAGEMENT SERVER

(71) Applicant: TOSHIBA TEC KABUSHIKI KAISHA, Tokyo (JP)

(72) Inventors: Keiichi HASEGAWA, Koto Tokyo (JP); Kazuya NAMBU, Nakano Tokyo (JP)

(21) Appl. No.: 16/987,291

(22) Filed: Aug. 6, 2020

Related U.S. Application Data
(63) Continuation of application No. 16/141,341, filed on Sep. 25, 2018.

(30) Foreign Application Priority Data
Sep. 25, 2017 (JP) 2017-183798

(51) Int. Cl. G06Q 20/20; G06Q 20/24; G06Q 20/38; G06Q 20/04

(52) U.S. Cl. CPC G06Q 20/204; G06Q 20/209; G06Q 20/047; G06Q 20/385; G06Q 20/24

(57) ABSTRACT

In accordance with an embodiment, a settlement system includes a register machine performing registration and checkout of commodities to be purchased based on a user code, and a user management server storing a linkage code in association with the user code and a credit card of the user. The user management server, in response to a selection of the linkage code, transmits to a processing server for the credit card of the user, a request to issue a token associated with the credit card of the user along with the linkage code, and upon receipt of the token generated by the processing server, transmits the token to a user terminal of the user. The register machine, upon receipt of the token from the user terminal as payment for the registered commodities, performs credit card settlement with the processing server using the token.

### CROSS-REFERENCE TO RELATED APPLICATION

This application is a continuation of U.S. patent application Ser. No. 16/141,341, filed Sep. 25, 2018, which is based upon and claims the benefit of priority from Japanese Patent Application No. 2017-183798, filed in Sep. 25, 2017, the entire contents of which are incorporated herein by reference.

### FIELD

Embodiments described herein relate generally to a settlement system including a user management server.

### BACKGROUND

In credit settlement using a credit card in a store, card data such as a card number recorded on a credit card is read by a reader or manually input by an operator. Thus, there is a risk that the card data is exposed to a third person.

Various settlement technologies without using the credit card have been proposed, but they are not widespread as the technologies are completely different from common existing credit settlement technologies.

Under these circumstances, a system is desired which can perform the credit settlement without largely changing an existing architecture and can also reduce a risk that the card data is known by a third person.

### DESCRIPTION OF THE DRAWINGS

FIG. 1 is a block diagram illustrating a schematic configuration of a settlement system according to an embodiment;

FIG. 2 is a block diagram illustrating a circuit configuration of main portions of a POS terminal in FIG. 1;

FIG. 3 is a block diagram illustrating a circuit configuration of main portions of a user terminal in FIG. 1;

FIG. 4 is a block diagram illustrating a circuit configuration of main portions of a receipt server in FIG. 1;

FIG. 5 is a diagram illustrating a data structure of a data record contained in a card list database in FIG. 4;

FIG. 6 is a diagram illustrating a data structure of a data record contained in a ranking list database in FIG. 4;

FIG. 7 is a block diagram illustrating a circuit configuration of main portions of a credit server in FIG. 1;

FIG. 8 is a diagram illustrating a data structure of a data record contained in a card database in FIG. 7;

FIG. 9 is a flowchart depicting an information processing by a processor in FIG. 2;

FIG. 10 is a sequence diagram relating to information transmission and reception in the settlement system in a case of credit settlement; and

FIG. 11 is a flowchart depicting an information processing by the processor in FIG. 4.

### DETAILED DESCRIPTION

In accordance with an embodiment, a settlement system comprises a register machine configured to perform registration and checkout of commodities to be purchased by a user in a retail store based on a user code that identifies the user; and a user management server configured to store a linkage code in association with the user code and a credit card of the user, the linkage code having a code that is different from a number of the credit card. The user management server, in response to a selection of the linkage code, transmits to a processing server for the credit card of the user, a request to issue a token associated with the credit card of the user along with the linkage code, and upon receipt of the token generated by the processing server, transmits the token to a user terminal of the user. The register machine, upon receipt of the token from the user terminal as payment for the registered commodities, performs credit card settlement with the processing server using the token.

Hereinafter, an embodiment of an invention is described with reference to the accompanying drawings.

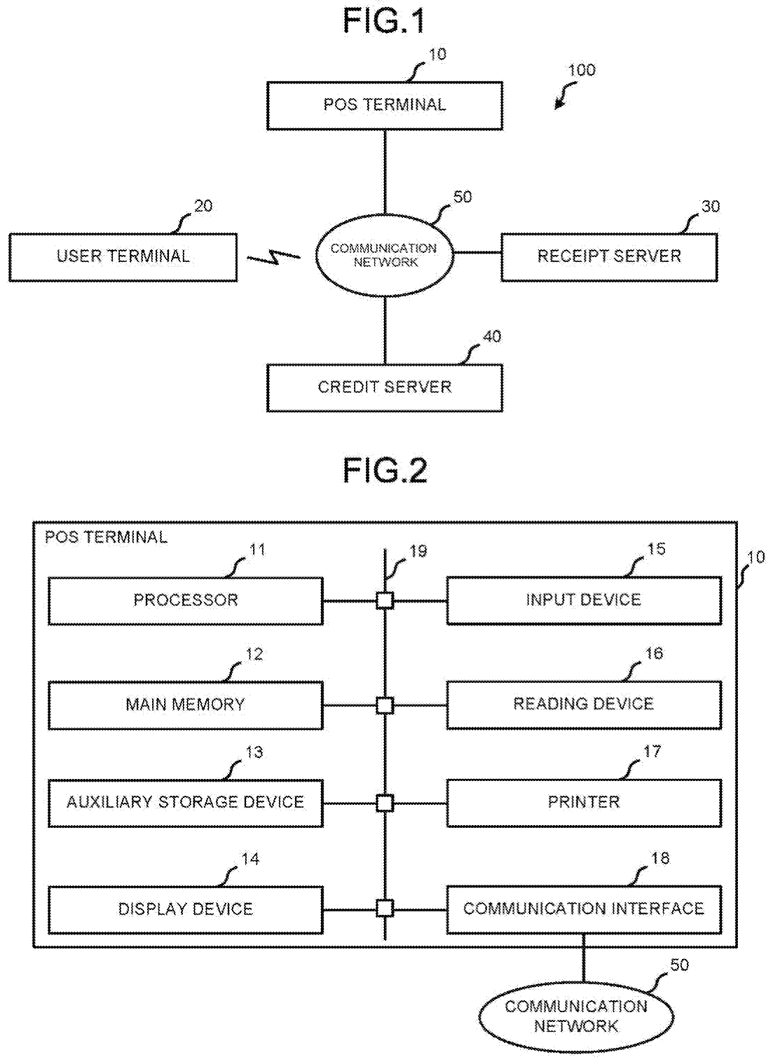

FIG. 1 is a block diagram illustrating a schematic configuration of a settlement system 100 according to an embodiment.

The settlement system 100 includes a POS (Point-Of-Sale) terminal 10, a user terminal 20, a receipt server 30, and a credit server 40. The POS terminal 10, the user terminal 20, the receipt server 30, and the credit server 40 can communicate with each other via a communication network 50. The communication network 50 may use the Internet, a VPN (Virtual Private Network), a LAN (Local Area Network), a public communication network, a mobile communication network, a dedicated line, etc. singly or in an appropriately combined manner. The settlement system 100 typically includes a plurality of the POS terminals 10 and a plurality of the user terminals 20, but in FIG. 1 only one POS terminal 10 and one user terminal 20 are shown. In the settlement system 100, a plurality of receipt servers 30 or credit servers 40 is provided in some cases.

The POS terminal 10 performs a processing for registering contents of a transaction such as commodity sales in the retail store and performing checkout of the transaction or the like. The checkout processing includes a processing of calculating a payment amount and a processing of settling the payment amount. Thus, the POS terminal 10 functions as a settlement reception apparatus that performs registration and checkout of commodities to be purchased by the user in the retail store.

The user terminal 20 displays a screen for browsing contents of a transaction and a result of the checkout in response to an operation by a user of an electronic receipt service provided by the receipt server 30. If a plurality of the user terminals 20 is contained in the settlement system 100, these plural user terminals 20 may be used by the same user or may be individually used by different users. Alternatively, one user terminal 20 may be shared by plural users.

The receipt server 30 acquires receipt data indicating contents of a transaction settled in the POS terminal 10 and the result of the checkout from the POS terminal 10 to store them. The receipt server 30 generates receipt screen data indicating a receipt image showing a content of the receipt data, and transmits the receipt screen data to the user terminal 20. The receipt server 30 functions as a user management apparatus which manages a user code for identifying a user for the management of the receipt data.

The credit server 40 executes a processing for credit settlement. In other words, the credit server 40 functions as a credit processing apparatus.

FIG. 2 is a block diagram illustrating a circuit configuration of main portions of the POS terminal 10.

The POS terminal 10 includes a processor 11, a main memory 12, an auxiliary storage device 13, a display device 14, an input device 15, a reading device 16, a printer 17, a communication interface 18, and a transmission path 19.

The processor 11, the main memory 12 and the auxiliary storage device 13 in the POS terminal 10 are connected with each other through the transmission path 19 to constitute a computer for performing an information processing for controlling the POS terminal 10.

The processor 11 acts as a central part of the computer. The processor 11 controls each section to realize various functions of the POS terminal 10 by executing operating systems and application programs. The main memory 12 includes a non-volatile memory area and a volatile memory area. The main memory 12 stores the operating systems and the application programs in the non-volatile memory area. The main memory 12 stores data necessary for the processor 11 to execute a processing for controlling each section in the non-volatile or volatile memory area in some cases. The main memory 12 uses the volatile memory area as a work area where data is appropriately rewritten by the processor 11.

The auxiliary storage device 13 acts as an auxiliary storage section of the computer. The auxiliary storage device 13 is, for example, an EEPROM (Electric Erasable Programmable Read-Only Memory), an HDD (Hard Disk Drive), an SSD (Solid State Drive), or other well-known storage devices. The auxiliary storage device 13 stores data used for the processor 11 to execute various processing and data generated in the processing by the processor 11. The auxiliary storage device 13 stores the application programs in some cases.

The display device 14 displays various screens for notifying an operator of various information. For example, a well-known device such as a liquid crystal display device may be provided as the display device 14.

The input device 15 inputs various instructions by the operator. Well-known devices such as a touch sensor or a keyboard may be provided alone or in a combined manner as the input device 15.

The reading device 16 reads data stored or displayed in a recording medium. Well-known devices such as a barcode scanner or a card reader may be used alone or in a combined manner as the reading device 16.

The printer 17 issues a receipt (hereinafter, referred to as a paper receipt) after printing a receipt image on a receipt paper.

The communication interface 18 performs data communication via the communication network 50. For example, a well-known device which can perform a well-known processing for data communication via the Internet may be provided as the communication interface 18.

The transmission path 19 includes an address bus, a data bus, a control signal line, and the like, and transmits data and control signals transmitted and received between the connected sections.

The POS terminal 10 stores an application program for executing an information processing described later in the main memory 12 or the auxiliary storage device 13. The application program may be stored in the main memory 12 or the auxiliary storage device 13 at the time of transfer of hardware of the POS terminal 10 or may be transferred separately from the above hardware. In the latter case, the application program is recorded in a removable recording medium such as a magnetic disk, a magneto-optical disk, an optical disk, a semiconductor memory, etc., or is transferred via the network.

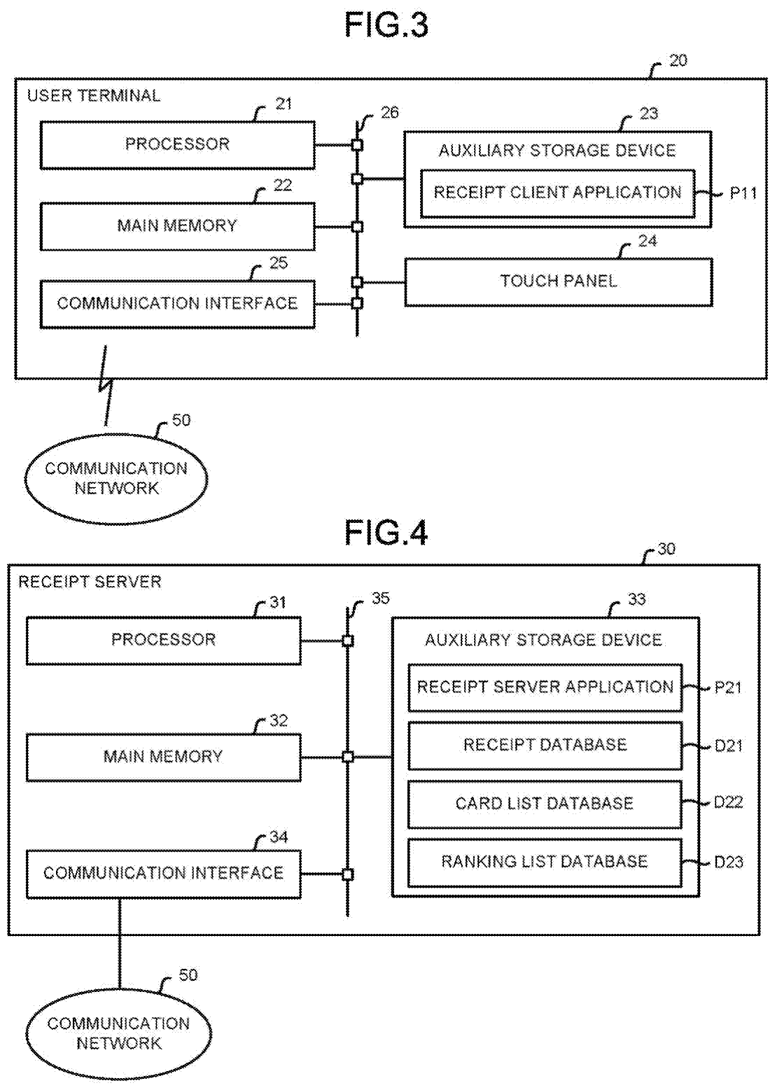

FIG. 3 is a block diagram illustrating a circuit configuration of main portions of the user terminal 20.

The user terminal 20 is typically a portable type information processing apparatus such as a smartphone, a mobile phone, a tablet terminal, or the like. The user terminal 20 may be a stationary type information processing apparatus such as a desktop type personal computer or the like.

The user terminal 20 includes a processor 21, a main memory 22, an auxiliary storage device 23, a touch panel 24, a communication interface 25, a transmission path 26, and the like.

In the user terminal 20, the processor 21, the main memory 22, and the auxiliary storage device 23 are connected with each other through the transmission path 26 to constitute a computer that performs an information processing for controlling the user terminal 20.

The processor 21 acts as a central part of the computer. The processor 21 controls each section to realize various functions of the user terminal 20 by executing operating systems and application programs.

The main memory 22 includes a non-volatile memory area and a volatile memory area. The main memory 22 stores operating systems and application programs in the non-volatile memory area. The main memory 22 stores data necessary for the processor 21 to execute a processing for controlling each section in the non-volatile or volatile memory area in some cases. The main memory 22 uses the volatile memory area as a work area where data is appropriately rewritten by the processor 21.

The auxiliary storage device 23 acts as an auxiliary storage section of the computer. The auxiliary storage device 23 is, for example, an EEPROM. The auxiliary storage device 23 may also be an HDD, an SSD, or the like. The auxiliary storage device 23 stores data to be used for the processor 21 to execute various processing and data generated in the processing by the processor 21. The auxiliary storage device 23 stores the application program.

One of the application programs stored in the auxiliary storage device 23 is an information processing program (hereinafter, referred to as a receipt client application) P11 for operating as a receipt client. Typically, however, the receipt client application P11 is downloaded via, for example, the Internet to be written in the auxiliary storage device 23 in response to an operation by a user of the user terminal 20. In other words, the transfer of the user terminal 20 to the user of the user terminal 20 is performed in a state in which the receipt client application P11 is not stored in the auxiliary storage device 23. However, the user terminal 20 in the state in which the receipt client application P11 is stored in the auxiliary storage device 23 may be transferred to the user of the user terminal 20.

The touch panel 24 functions as an input device and a display device of the user terminal 20.

The communication interface 25 is an interface for data communication via the communication network 50. As the communication interface 25, for example, a well-known communication device for performing data communication via a mobile communication network or the Internet may be provided.

The transmission path 26 includes an address bus, a data bus, a control signal line, and the like, and transmits data and control signals transmitted and received between the connected sections.

FIG. 4 is a block diagram illustrating a circuit configuration of main portions of the receipt server 30.

The receipt server 30 includes a processor 31, a main memory 32, an auxiliary storage device 33, a communication interface 34, a transmission path 35, and the like.

In the receipt server 30, the processor 31, the main memory 32, and the auxiliary storage device 33 are connected with each other through the transmission path 35 to constitute a computer for performing an information processing for controlling the receipt server 30.

The processor 31 acts as a central part of the computer. The processor 31 controls each section to realize various functions of the receipt server 30 by executing operating systems and application programs.

The main memory 32 includes a non-volatile memory area and a volatile memory area. The main memory 32 stores the operating systems and the application programs in the non-volatile memory area. The main memory 32 stores data necessary for the processor 31 to execute a processing for controlling each section in the non-volatile or volatile memory area in some cases. The main memory 32 uses the volatile memory area as a work area where data is appropriately rewritten by the processor 31.

The auxiliary storage device 33 acts as an auxiliary storage section of the computer. The auxiliary storage device 33 is, for example, an EEPROM, an HDD, an SSD, or the like. The auxiliary storage device 33 stores data used for the processor 31 to execute various processing and data generated in the processing by the processor 31. The auxiliary storage device 33 stores the application programs in some cases. One of the application programs stored in the auxiliary storage device 33 is an information processing program (hereinafter, referred to as a receipt server application) P21 for operating as the receipt server 30.

The communication interface 34 performs data communication via the communication network 50. As the communication interface 34, for example, a well-known communication device which can perform data communication via the Internet may be provided.

The transmission path 35 includes an address bus, a data bus, a control signal line, and the like, and transmits data and control signals transmitted and received between the connected sections.

For example, the receipt server 30 can use a general-purpose computer device as basic hardware. At this time, typically, the receipt server application P21 and the computer device in a state in which the receipt server application P21 is not stored in the auxiliary storage device 33 are individually transferred to an operator of the receipt server 30. The transfer of the receipt server application P21 can be realized by recording the receipt server application P21 in a removable recording medium such as a magnetic disk, a magneto-optical disk, an optical disk, a semiconductor memory or the like, or by downloading the receipt server application P21 via a network. In this case, the receipt server application P21 is written in the auxiliary storage device 33 in response to an operation by an administrator of the receipt server 30 or an installer of the receipt server 30 or the like.

The processor 31 uses a part of the storage area of the auxiliary storage device 33 to store a receipt database D21, a card list database D22, and a ranking list database D23. The receipt database D21 stores receipt data. The receipt data includes, for example, a transaction code, a member code, checkout data and details data. The transaction code is a unique code that identifies each transaction. The member code is a unique code for identifying a user of the electronic receipt service. In other words, the member code acts as the user code. The checkout data indicates a checkout result. Any data may be stored in the checkout data; for example, here, it is assumed that a date and time when the settlement is performed, a settlement amount, a settlement method, or a store code for identifying a retail store where the settlement is performed is contained in the checkout data. The details data indicates details of contents of the transaction which is the target of settlement.

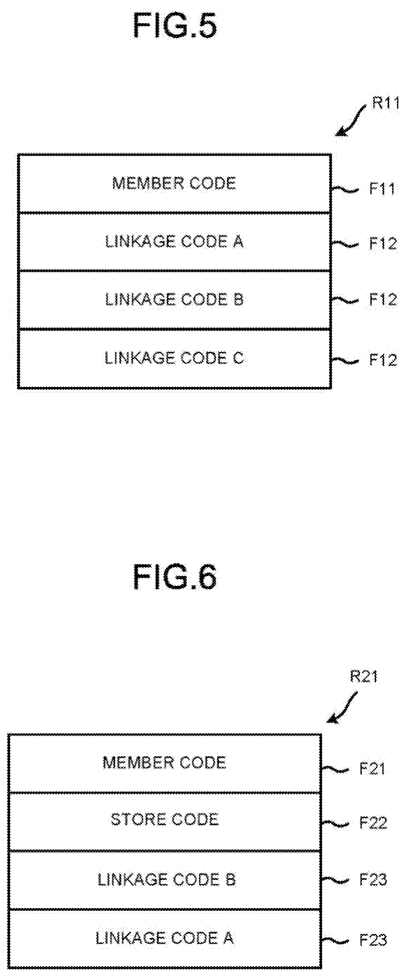

FIG. 5 shows a data structure of the data record R11 included in the card list database D22.

The card list database D22 is a set of data records R11. The data record R11 corresponds to each user of the electronic receipt service. The data record R11 includes a field F11 and at least one field F12. The data of the field F11 indicates a member code for identifying the corresponding user. The data of the field F12 indicates a linkage code set for the credit card used by the corresponding user. Therefore, the data record R11 includes the fields F12 the number of which corresponds to that of credit cards used by the corresponding user. FIG. 5 shows an example in which three credit cards are registered by the corresponding user. For this reason, the data record R11 shown in FIG. 5 includes three fields F12. Thus, by storing the card list database D22, the auxiliary storage device 33 functions as a storage module that stores the linkage code in association with the member code acting as the user code.

FIG. 6 is a diagram illustrating the data structure of the data record R21 included in the ranking list database D23.

The ranking list database D23 is a set of data records R21. The data record R21 is a combination of the code for a user of the electronic receipt service and the code for a retail store where the POS terminal 10 is installed. The data record R21 includes fields F21 and F22 and at least one field F23. The data of the field F21 indicates a member code for identifying the corresponding user. The data of the field F22 indicates a store code for identifying the corresponding retail store. The data in the field F23 indicates a linkage code set for the credit card used by the corresponding user. However, the field F23 indicates a linkage code of a credit card that is likely to be used by the corresponding user in the corresponding retail store, and arranged in order according to a priority order of those credit cards. The priority order may be manageable by adding another value indicating the priority order or the like.

FIG. 6 shows an example in which two credit cards can be used by a corresponding user in a corresponding retail store. For this reason, the data record R21 shown in FIG. 6 includes two fields F23. FIG. 6 shows an example in which the credit card associated with a “linkage code B” is more likely to be used than that associated with a “linkage code A”.

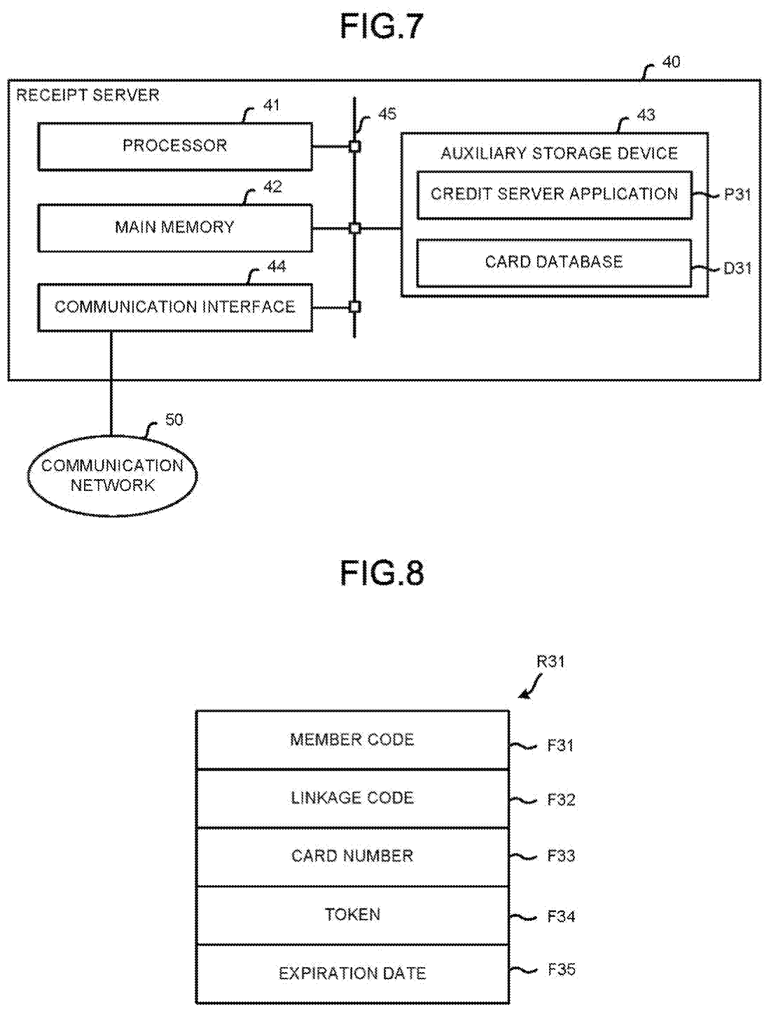

FIG. 7 is a block diagram illustrating a circuit configuration of main portions of the credit server 40.

The credit server 40 includes a processor 41, a main memory 42, an auxiliary storage device 43, a communication interface 44, a transmission path 45, and the like.

In the credit server 40, the processor 41, the main memory 42, and the auxiliary storage device 43 are connected with each other via the transmission path 45 to constitute a computer that performs an information processing for controlling the credit server 40.

The processor 41 acts as a central part of the computer. The processor 41 controls each section to realize various functions of the credit server 40 by executing operating systems and application programs.

The main memory 42 includes a non-volatile memory area and a volatile memory area. The main memory 42 stores the operating systems and the application programs in the non-volatile memory area. The main memory 42 stores data necessary for the processor 41 to execute a processing for controlling each section in the non-volatile or volatile memory area in some cases. The main memory 42 uses the volatile memory area as a work area where data is appropriately rewritten by the processor 41.

The auxiliary storage device 43 acts as an auxiliary storage section of the computer. The auxiliary storage device 43 is, for example, an EEPROM, an HDD, an SSD, or the like. The auxiliary storage device 43 stores data used for the processor 41 to execute various processing and data generated in the processing by the processor 41. The auxiliary storage device 43 stores the application programs in some cases. One of the application programs stored in the auxiliary storage device 43 is an information processing program (hereinafter, referred to as a credit server application) P31 for operating as the credit serer 40.

The communication interface 44 performs data communication via the communication network 50. As the communication interface 44, for example, a well-known communication device which can perform data communication via the Internet may be provided.

The transmission path 45 includes an address bus, a data bus, a control signal line, and the like, and transmits data and control signals transmitted and received between the connected sections.

For example, the credit server 40 can use a general-purpose computer device as basic hardware. At this time, typically, the credit server application P31 and the computer device in a state in which the credit server application P31 is not stored in the auxiliary storage device 43 are individually transferred to an operator of the credit server 40. The transfer of the credit server application P31 can be realized by recording the credit server application P31 in a removable recording medium such as a magnetic disk, a magneto-optical disk, an optical disk, a semiconductor memory or the like, or by downloading the credit server application P31 via the network. In this case, the credit server application P31 is written in the auxiliary storage device 43 in response to an operation by an administrator of the credit server 40 or an installer of the credit server 40 or the like.

The processor 41 uses a part of the storage area of the auxiliary storage device 43 to store a card database D31.

FIG. 8 is a diagram illustrating the configuration of a data record R31 included in the card database D31.

The card database D31 is a set of data records R31. The data record R31 corresponds to a combination of the user code of the electronic receipt service and the credit card number used by the user, respectively. The data record R31 includes fields F31, F32, F33, F34, and F35. The data of the field F31 indicates a member code for identifying the corresponding user. The data of the field F32 indicates a linkage code set for the corresponding credit card. The data in the field F33 indicates a card number for identifying the corresponding credit card. The card number is an example of a credit code. The data of the field F34 indicates a token described later. The data of the field F35 indicates an expiration date of the token indicated by the data of the field F34.

Next, the operation of the settlement system 100 configured as described above is described. The contents of various processing described below are merely examples, and various processing capable of achieving the same results can be appropriately used.

First, a user who uses the settlement system 100 performs user registration for an operator of the receipt server 30 (hereinafter, referred to as a receipt service provider) and acquires the member code. If the user wants to use the credit settlement service provided by the receipt server 30 in the electronic receipt service, the user notifies the card number of the credit card to be used therein to the receipt service provider. The receipt service provider notifies the notified card number to the operator of the credit server 40 (hereinafter, referred to as a credit service provider). The credit service provider issues a linkage code in association with the notified card number and generates the data record R31 in which the member code, the linkage code and the card number are set in the fields F31, F32 and F33, and adds the data record R31 to the card database D31. The credit service provider notifies the receipt service provider of the linkage code. The receipt service provider creates the data record R11 in which the member code and the linkage code are set in the fields F11 and F12 and adds the data record R11 to the card list database D22. If the data record R11 in which the corresponding member code is set in the field F11 is already contained in the card list database D22, the receipt service provider updates the data record R11 so as to contain a new field F12 in which the linkage code newly notified is set. The above processing may be performed automatically by the receipt server 30 and the credit server 40, or may be performed via an operation by an attendant belonging to the receipt service provider and the credit service provider.

When the POS terminal 10 is in the operation state of performing the purchase registration and the checkout, the processor 11 executes the processing described below by executing the application program stored in the main memory 12 or the auxiliary storage device 13.

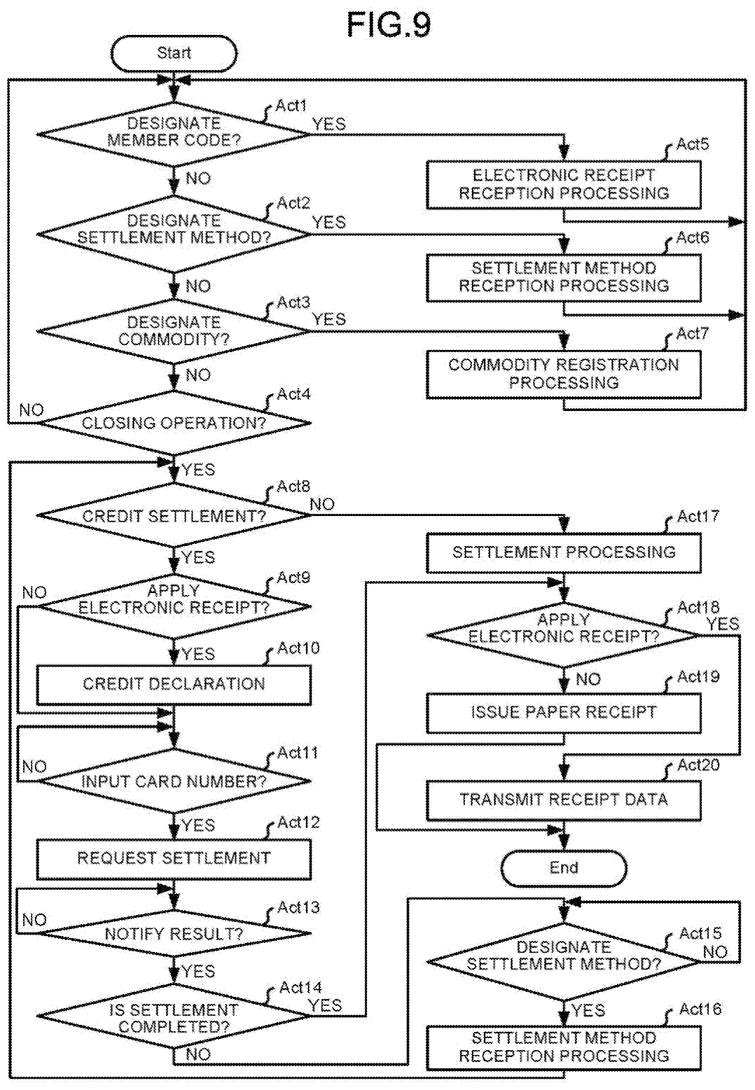

FIG. 9 is a flowchart depicting an information processing by the processor 11.

In Act 1, the processor 11 determines whether or not the member code is designated. Then, if the member code is not designated, the processor 11 determines No, and proceeds to the processing in Act 2.

In Act 2, the processor 11 determines whether or not the settlement method is designated. If the settlement method is not designated, the processor 11 determines No, and proceeds to the processing in Act 3.

In Act 3, the processor 11 determines whether or not the commodity to be purchased is designated. Then, if the commodity is not designated, the processor 11 determines No and proceeds to the processing in Act 4.

In Act 4, the processor 11 determines whether or not a closing operation is performed. Then, if the corresponding operation is not performed, the processor 11 determines No and returns to the processing in Act 1.

In this way, the processor 11 stands by until the member code in Act 1, the settlement method in Act 2, or the designation of the commodity in Act 3 is designated, or the closing operation in Act 4 is performed.

If the user wants to purchase a commodity in the retail store, the user performs the purchase registration and the checkout of the commodity with the POS terminal 10 installed in the retail store. The operation of the POS terminal 10 may be performed by either a store clerk in the retail store or the user. In the following, it is assumed that the operation of the POS terminal 10 is performed by the store clerk.

At this time, the user presents the member code to the store clerk at any time before the closing operation is performed. As an example, the user enables barcode indicating the member code to be displayed on the touch panel 24 through an information processing realized by the processor 21 executing the receipt client application P11 in the user terminal 20. It is desirable that the processor 21 authenticates the user and displays the barcode only when the authentication is successful. Then, the user presents the barcode displayed on the touch panel 24 to the store clerk in this way. By doing this, the store clerk uses the reading device 16 to read the barcode. The reading device 16 acquires the member code by reading the barcode. If the member code is acquired in this way, the processor 11 determines that the member code is designated and determines Yes in Act 1, and then proceeds to the processing in Act 5. In this operation, the reading device 16 functions as a first acquisition module for acquiring the user code.

In Act 5, the processor 11 performs an electronic receipt reception processing. The electronic receipt reception processing is a processing for managing the applying of the electronic receipt service to the transaction which is a commodity registration target. Specifically, for example, the processor 11 sets an electronic receipt flag associated with the transaction code for identifying the transaction, and stores the member code in association with the transaction code. Then, the processor 11 returns to the standby state in Act 1 to Act 4.

On the other hand, if the user wants to perform the settlement using a settlement method different from a standard settlement method defined in the POS terminal 10 or a settlement method different from the already changed settlement method, the user notifies the intention to the store clerk. By doing this, the store clerk operates the input device 15 to designate the settlement method. In response to that, the processor 11 determines Yes in Act 2 and proceeds to the processing in Act 6.

In Act 6, the processor 11 performs a settlement method reception processing. Specifically, the processor 11 sets the designated settlement method as the settlement method. More specifically, for example, the processor 11 changes a value of settlement method data for managing the settlement method to a value indicating the designated settlement method. Then, the processor 11 returns to the standby state in Act 1 to Act 4.

The store clerk designates commodities to be purchased by the user one by one in the POS terminal 10. For example, the store clerk uses the reading device 16 to read the barcode indicating the commodity code attached to the corresponding commodity. If the commodity code can be acquired in this way, the processor 11 determines that the commodity is designated and determines Yes in Act 3, and then proceeds to the processing in Act 7.

In Act 7, the processor 11 performs a commodity registration processing. Specifically, for example, the processor 11 updates the commodity list so as to contain the commodity code acquired as described above. Then, the processor 11 returns to the standby state in Act 1 to Act 4.

After completing registration of all the commodities that the user wants to purchase, if the store clerk executes a checkout processing next, the store clerk performs a predetermined closing operation with the input device 15, for example. Then, the processor 11 determines Yes in Act 4 and proceeds to the processing in Act 8.

In Act 8, the processor 11 determines whether or not the credit settlement is set as the settlement method. Then, for example, if the value of the settlement method data is a value indicating the credit settlement, the processor 11 determines Yes and proceeds to the processing in Act 9.

In Act 9, the processor 11 determines whether or not the electronic receipt service is required to be applied. For example, if it is determined that the electronic receipt flag is in the set state, the processor 11 determines Yes. Then, the processor 11 proceeds to the processing in Act 10.

In Act 10, the processor 11 issues a credit declaration to the receipt server 30. Specifically, the processor 11 transmits data including a predetermined command for the credit declaration, the member code, and the store code for identifying the retail store where the POS terminal 10 is installed to the receipt server 30 from the communication interface 18.

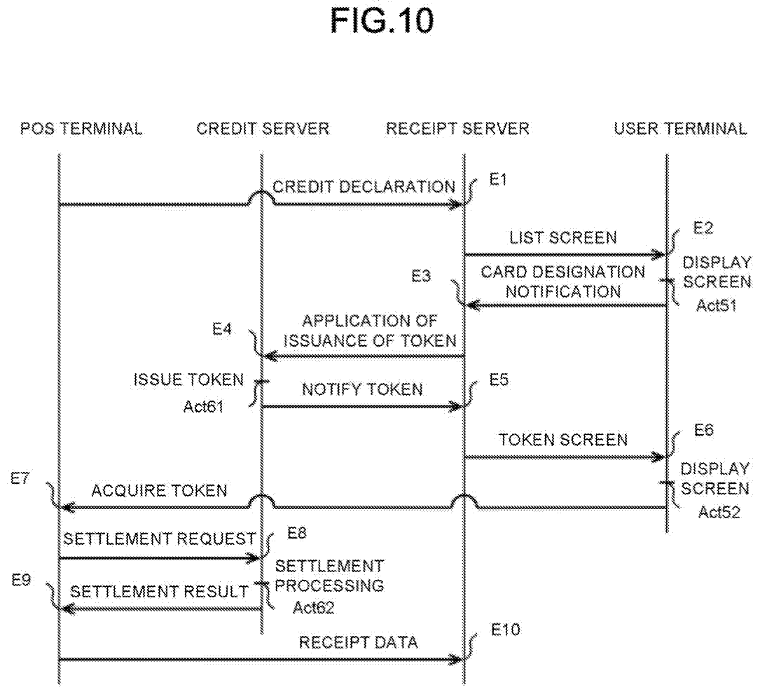

FIG. 10 is a sequence diagram relating to transmission and reception of the information in the settlement system 100 in the case of the credit settlement.

As indicated as an event E1 in FIG. 10, the above data for the credit declaration is transmitted to the receipt server 30 via the communication network 50. By doing this, the data is received by the receipt server 30 through the communication interface 34. The data includes a member code as described above. Therefore, the communication interface 34 acquires the member code as the user code from the POS terminal 10 as the settlement reception apparatus, and functions as a second acquisition module.

When the receipt server 30 is in the normal operation state, the processor 31 executes the processing described below by executing the receipt server application P21.

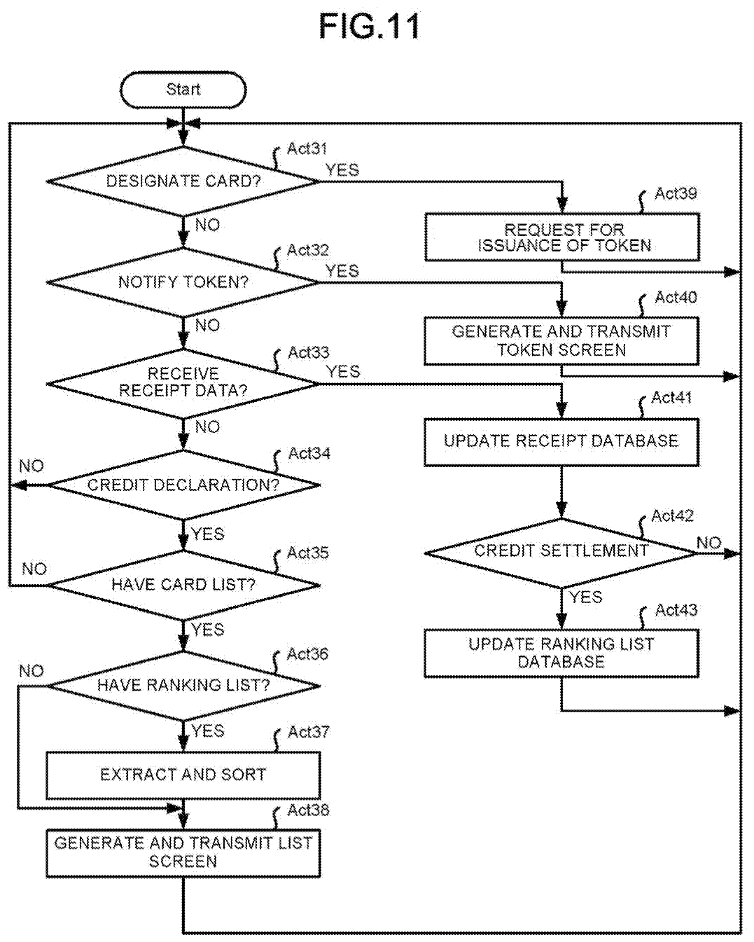

FIG. 11 is a flowchart depicting an information processing by the processor 31.

In Act 31, the processor 31 determines whether or not a credit card is designated. Then, if the corresponding designation is not performed, the processor 31 determines No, and proceeds to the processing in Act 32.

In Act 32, the processor 31 determines whether or not a token is notified. Then, if the corresponding notification is not issued, the processor 31 determines No, and proceeds to the processing in Act 33.

In Act 33, the processor 31 determines whether or not the receipt data is received. Then, if the receipt data is not received, the processor 31 determines No, and proceeds to the processing in Act 34.

In Act 34, the processor 31 determines whether or not the credit declaration is made. Then, if the credit declaration is not made, the processor 31 determines No and returns to the processing in Act 31.

In this way, the processor 31 stands by until the credit card is designated in Act 31, the token is notified in Act 32, the reception data is received in Act 33, or the credit declaration is made in Act 34. If the data for the credit declaration is received by the communication interface 34 as described above, the processor 31 determines Yes in Act 34 and proceeds to the processing in Act 35.

In Act 35, the processor 31 determines whether or not there is a card list relating to the user who is going to use the credit settlement. Specifically, for example, if the data record R11 in which the member code contained in the credit declaration is set in the field F11 is contained in the card list database D22, the processor 31 determines that there is the card list and determines Yes, and proceeds to the processing in Act 36.

In Act 36, the processor 31 determines whether or not there is a ranking list relating to the user. For example, if the data record R21 in which the member code and store code contained in the credit declaration are set in the fields F21 and F22 is contained in the ranking list database D23, the processor 31 determines that there is the ranking list and determines Yes, and then proceeds to the processing in Act 37.

In Act 37, the processor 31 extracts linkage codes which indicate options of the credit cards to be used and sorts them. Specifically, for example, the processor 11 extracts a linkage code which matches the linkage code set in the field F23 of the data record R21 found in Act 36 from the linkage code set in the field F12 of the data record R11 found in Act 35. Furthermore, if there is a plurality of linkage codes extracted in this manner, the processor 31 sorts them according to an arrangement order in the data record R21. However, the above processing is merely an example, and the processor 31 may perform the processing according to any predetermined rule. For example, after extracting and sorting the linkage codes as described above, a linkage code that is not extracted may be added thereafter.

After finishing the processing in Act 37, the processor 31 proceeds to the processing in Act 38. If the corresponding data record R21 is not found in Act 36, the processor 31 determines No in Act 36, passes Act 37 and proceeds to the processing in Act 38.

In Act 38, the processor 31 generates a list screen, and transmits the data of the list screen to the user terminal 20 used by the user. The list screen is a screen for presenting a list of usable credit cards to the user to enable the user to select a credit card to use. If the processing in Act 37 is passed, the processor 31 generates a list screen as a screen for showing a list of linkage codes set in the field F12 of the data record R11 found in Act 35. If the processing in Act 37 is executed, the processor 31 generates a list screen as a screen for showing a list of linkage codes after extraction and sorting. The processor 31 may generate the list screen so as to show a brand name of each credit card or a part of the card number in association with the linkage code, and then cause the touch panel 24 of the user terminal 20 to display it on the list screen. However, the whole card number is not shown on the list screen. Then, the processor 31 controls the communication interface 34 to transmit the data of the list screen to the user terminal 20 corresponding to the member code contained in the credit declaration. If the processor 31 finishes transmitting the data of the list screen, the processor 31 returns to the standby state in Act 31 to Act 34.

As shown as an event E2 in FIG. 10, the data on the list screen is transmitted to the user terminal 20 via the communication network 50. By doing this, the data is received by the user terminal 20 through the communication interface 25. In response to this, the processor 21 controls the touch panel 24 to display the list screen as the Act 51 shown in FIG. 10. The user confirms the list screen and operates the touch panel 24 so as to designate the credit card to be used for the credit settlement. In response to this operation, the processor 21 controls the communication interface 25 to transmit the data for notifying the designated credit card to the receipt server 30.

As indicated as an event E3 in FIG. 10, the above data for notifying the designated credit card is transmitted to the receipt server 30 via the communication network 50. Then, the data is received by the receipt server 30 through the communication interface 34. In response to that, the processor 31 determines Yes in Act 31 in FIG. 11 and proceeds to the processing in Act 39.

In Act 39, the processor 31 controls the communication interface 34 to transmit to the credit server 40 a request for issuance of the token. Specifically, for example, the processor 31 controls the communication interface 34 to transmit the data including a predetermined command indicating that it is an application for issuance of the token, the member code, and the linkage code of the designated credit card to the credit server 40. Then, the processor 31 returns to the standby state in Act 31 to Act 34. Thus, the processor 31 executes the information processing by executing the receipt server application P21, and in this way, the computer having the processor 31 as the central part functions as a first notifying module. The computer having the processor 31 as the central part selects the linkage code contained in the data for applying for issuance of the token in response to an instruction of the user, and functions as a selection module.

As shown as an event E4 in FIG. 10, the above data for application is transmitted to the credit server 40 via the communication network 50. By doing this, the data is received by the credit server 40 through the communication interface 44. In response to that, the processor 41 issues the token in Act 61 shown in FIG. 10. Specifically, for example, the processor 41 issues a number different from the card number as the token according to a predetermined algorithm. Any form of the token may be used, but here it is a 16-digit number, which is the same as the card number. The processor 41 determines an expiration date as a date and time after a predetermined effective time elapses from the current date and time. In other words, the token issued here has an effective period from the time point of the issuance to the expiration date. The processor 41 then updates the card database D31 so as to contain these tokens and expiration dates. In other words, the processor 41 sets the above-mentioned token and expiration date in the fields F34 and

F35 of the data record R31 in which the member code and the linkage code contained in the data for token application are respectively set in the fields F31 and F32. As a result, in the card database D31, the token is managed in association with the card number. Here, the token acts as an identification code for settlement using the credit card identified by the linkage code.

Then, the processor 41 controls the communication interface 44 to transmit the data including a predetermined command indicating that it is the notification of the token and the token to the receipt server 30 through the communication network 50.

As shown as an event E5 in FIG. 10, the above-described data for token notification is transmitted to the receipt server 30 through the communication network 50. Then, the data is received by the receipt server 30 through the communication interface 34. In response to this, the processor 31 determines Yes in Act 32 in FIG. 11 and proceeds to the processing in Act 40.

In Act 40, the processor 31 generates a token screen and transmits the data of the token screen to the user terminal 20 used by the user. The token screen is a screen for causing the POS terminal 10 to receive the token notified from the credit server 40. Specifically, for example, the processor 31 generates the token screen as a screen for showing a barcode indicating the corresponding token, for example. Thus, by sending the token screen to the user terminal 20, the token as the identification code is notified to the user. Thus, the processor 31 executes the information processing by executing the receipt server application P21, and in this way, the computer having the processor 31 as the central part functions as a second notifying module.

For example, the processor 31 can determine the user terminal 20 which is a transmission destination of the token screen data by associating the member code with a session code of a session established between the receipt server 30 and the credit server 40 for applying the issuance of the token and notifying the token. Alternatively, the credit server 40 may notify the receipt server 30 of the member code contained in the token application together with the data of the token screen, and in this way, the processor 31 can determine the user terminal 20 which is the transmission destination of the token screen. Then, the processor 31 controls the communication interface 34 to transmit the data of the token screen to the user terminal 20 determined based on the above operations. Then, the processor 31 returns to the standby state in Act 31 to Act 34.

As shown as event E6 in FIG. 10, the above data of the token screen is transmitted to the user terminal 20 via the communication network 50. By doing this, the data is received by the user terminal 20 through the communication interface 25. In response to that, the processor 21 controls the touch panel 24 to display the token screen in Act 52 shown in FIG. 10. The user presents the token screen to the store clerk. The store clerk uses the reading device 16 to read the barcode shown on the token screen. As a result, as shown as an event E7 in FIG. 10, the token is received by the POS terminal 10. Thus, the reading device 16 functions as a third acquisition module which acquires the token as the identification code.

The reception of the token in the POS terminal 10 from the user terminal 20 may be performed through wireless communication such as NFC (Near Field Communication), or by the store clerk inputting numerals with the input device 15. In these cases, for example, the token screen is a screen for guiding the POS terminal 10 to receive the token.

In the POS terminal 10, after executing the credit declaration in Act 10 as described above, the processor 11 proceeds to the processing in Act 11.

In Act 11, the processor 11 stands by until the card number of the credit card used for settlement is input. If the token is received as described above, the processor 11 determines the reception of the token as the input of the card number, and determines Yes, and then proceeds to the processing in Act 12. If the card number recorded on the credit card is read by the reading device 16, the processor 11 determines Yes as well.

In Act 12, the processor 11 issues a settlement request to the credit server 40. Specifically, for example, the processor 11 calculates a settlement amount relating to the commodity indicated in the commodity list. Then, the processor 11 controls the communication interface 18 to transmit data including a predetermined command indicating a request for settlement, the settlement amount, and the token or card number acquired as described above, to the credit server 40. Thus, the processor executes the information processing by executing the application program, and in this way, the computer having the processor 11 as the central part functions as a request module for requesting the credit settlement.

As shown as an event E8 in FIG. 10, the above data for the settlement request is transmitted to the credit server 40 via the communication network 50. By doing this, the data is received by the credit server 40 through the communication interface 44. In response to this, the processor 41 performs a settlement processing in Act 62 shown in FIG. 10. The settlement processing is a well-known processing for settling a payment amount using the credit card. However, if the token is contained in the above data for the settlement request, the processor 41 refers to the card database D31 to confirm whether or not the token is valid, and if it is valid, the processor 41 performs the settlement using the card number associated with the token.

If the settlement is completed, or the settlement is abandoned due to some circumstances, the processor 41 controls the communication interface 44 to transmit the data indicating the result to the POS terminal 10 as a predetermined command indicating that it is the notification of the result.

As shown as an event E9 in FIG. 10, the above data for notifying the result is transmitted to the POS terminal 10 via the communication network 50. By doing this, the data is received by the POS terminal 10 through the communication interface 18.

In the POS terminal 10, if the settlement is requested as described above in Act 12, the processor 11 proceeds to the processing in Act 13.

In Act 13, the processor 11 waits for the notification of the result. Then, if the data indicating the notification of the result is received as described above, the processor 11 determines Yes and proceeds to the processing in Act 14.

In Act 14, the processor 11 determines whether or not the settlement is completed based on the data indicating the notification of the result. Then, if the settlement is abandoned, the processor 11 determines No and proceeds to the processing in Act 15.

In Act 15, the processor 11 stands by until a new settlement method is designated. At this time, for example, the processor 11 controls the display device 14 to notify the store clerk that the credit settlement using the previously input card number cannot be performed and display a screen for promoting the designation of the new settlement method. Then, if the operation for designating the settlement method is performed with the input device 15, the processor 11 determines Yes, and proceeds to the processing in Act 16.

In Act 16, the processor 11 performs the settlement method reception processing. The settlement method reception processing may be the same as that performed in Act 6, for example. Then, the processor 11 repeats the processing subsequent to Act 8 in the same way as described above.

In Act 6 or Act 16, if the credit settlement is not set as the settlement method to be used, the processor 11 determines No in Act 8 and proceeds to the processing in Act 17.

In Act 17, the processor 11 performs the settlement using the set settlement method. In other words, the processor 11 performs the settlement using a settlement method other than the credit settlement. If the settlement is completed, the processor 11 proceeds to the processing in Act 18. If it is determined that the credit settlement is completed, the processor 11 determines Yes in Act 14 and also proceeds to the processing in Act 18 in this case.

In Act 18, the processor 11 determines whether or not the transaction of which the settlement is completed is an applying target of the electronic receipt service. Specifically, for example, the processor 11 determines whether or not the electronic receipt flag is set. Then, if the electronic receipt flag is in a reset state, the processor 11 determines No, and proceeds to the processing in Act 19.

In Act 19, the processor 11 controls the printer 17 to issue a paper receipt for the above transaction of which the settlement is completed. The paper receipt may be issued in the same way as in an existing POS terminal. Then, the processor 11 terminates the information processing.

On the other hand, if the electronic receipt flag is in a set state, the processor 11 determines Yes in Act 18 and proceeds to the processing in Act 20.

In Act 20, the processor 11 generates receipt data relating to the above transaction of which the settlement is completed, and transmits the receipt data from the communication interface 18 to the receipt server 30. Then, the processor 11 terminates the information processing.

After temporarily terminating the information processing shown in FIG. 9, for example, the processor 11 performs an initialization processing such as clearing the commodity list or setting the value of the settlement method data as a value indicating a default settlement method, and then starts the information processing again.

As shown as an event E10 in FIG. 10, the receipt data is transmitted to the receipt server 30 via the communication network 50. By doing this, the receipt data is received by the receipt server 30 through the communication interface 34. In response to this, the processor 31 determines Yes in Act 33 in FIG. 11 and proceeds to the processing in Act 41.

In Act 41, the processor 31 updates the receipt database D21 so as to reflect the above received receipt data.

In Act 42, the processor 31 determines whether or not the credit settlement is performed based on the above received receipt data. Then, if the credit settlement is performed, the processor 31 determines Yes and proceeds to the processing in Act 43.

In Act 43, the processor 31 updates the ranking list database D23. An update rule of the ranking list database D23 here may be arbitrarily determined by, for example, a creator of the receipt server application P21. As an example, the processor 31 extracts, from the receipt data, the member code of the member who performs the transaction and the store code of the retail store where the transaction is performed. Then, the processor 31 selects the data record R21 in which the member code and the store code are set in the fields F21 and F22 as an update target from the ranking list database D23. If the corresponding data record R21 is not contained in the ranking list database D23, the processor 31 adds such a data record R21 to the ranking list database D23, and sets the data record R21 as the update target. If the linkage code associated with the credit card used for settlement is not contained in the data record R21 to be updated, the processor 31 adds the new field F23 in which the corresponding linkage code is set after the field F22. If the linkage code associated with the credit card to be used for settlement is already contained in the data record R21 which is the update target, the processor 31 rearranges the field F23 in which the corresponding linkage code is set in such a manner that the field F23 is positioned after the field F22. In other words, the processor 31 positions a linkage code associated with the newly used credit card ahead in the data record R21. It is also considered that the processor 31 counts the number of times each linkage code is used, and positions the linkage code more frequently used ahead in the data record R21.

The linkage code associated with the credit card used for the settlement is not contained in the receipt data. Therefore, for example, the processor 31 acquires a transaction code for identifying a transaction from the POS terminal 10 at the time of credit declaration, manages the transaction code and the linkage code contained in the data for applying issuance of the token in an associated manner. Then, the processor 31 determines the linkage code associated with the credit card used for settlement as the linkage code managed in association with the transaction code contained in the receipt data.

Then, the processor 11 returns to the standby state in Act 1 to Act 4. If the credit settlement is not performed, the processor 31 determines No in Act 42, passes Act 43, and returns to the standby state in Act 31 to Act 34.

According to the settlement system 100 as described above, if the credit card is previously registered, the user of the electronic receipt service can use the credit settlement by presenting the token displayed on the user terminal 20. In other words, the user can use the credit settlement without presenting the credit card or inputting a credit number, thereby improving the convenience of the user. Then, the token has a valid period, and if it is beyond the valid period, the token cannot be used for the credit settlement. Therefore, even if a token screen displayed by the user terminal 20 is photographed by a third person or the like, the credit settlement using such a token screen is prevented. Since the POS terminal 10 only uses the token instead of the card number, it is possible to realize the POS terminal 10 by using the existing POS terminal corresponding to the settlement by credit card without any change.

Especially according to the settlement system 100, the token has the same number of digits as the card number. Therefore, in the POS terminal 10, it is possible to handle the token in the same way as the card number, and the minimum modification can be performed on the existing POS terminal to obtain POS terminal 10.

According to the settlement system 100, it is possible to register plural credit cards for one user and select one of these plural credit cards to use for each settlement.

According to the settlement system 100, on the list screen for enabling the user to select one of the plural credit cards, a plurality of credit cards as options is displayed in order according to the actual usage in each retail store. Therefore, on the list screen, it is possible to arrange a credit card that the user is highly likely to select for presentation ahead in the list screen, thereby improving the convenience of the user.

The aforementioned embodiments can be modified as follows.

In the settlement system 100, the credit payment service is to be provided to the member of the electronic receipt service as a service among the electronic receipt service. However, it can be realized as an independent credit settlement service separate from the electronic receipt service, or it can be realized as a part of services for the member in addition to the electronic receipt service.

The ranking list database D23 may be arbitrarily editable in response to an instruction from the user.

A part or all of the functions realized by the processors 11, 21, 31, and 41 by executing the information processing can be realized by hardware which executes information processing not based on the program, such as a logic circuit or the like. Each of the above-described functions can also be realized by combining software control with hardware such as the above logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. (canceled)

2. A settlement system comprising:
a register machine configured to perform an operation for settlement of a transaction with a user at a store; and
a user management server, wherein
the register machine is configured to perform an operation to obtain a user code of the user,
the user management server is configured to:
store a linkage code in association with the user code, the linkage code identifying a credit card of the user and being different from a credit code thereof,
obtain the linkage code associated with the user code obtained by the register machine, and perform a notification of the obtained linkage code to a credit card processing server, and
receive an identification code having an expiration time, that is sent from the credit card processing server in response to the notification, and send the received identification code to a user terminal of the user, the identification code being different from the credit code and the linkage code, and
the register machine is configured to:
perform an operation to obtain the identification code from the user terminal, and
send a request for a credit card settlement using the obtained identification code to the credit card processing server.

3. The settlement system according to claim 2, wherein the user management server is configured to:
store a plurality of linkage codes in association with the user code, each linkage code identifying a credit card of the user and being different from a credit code thereof, and
obtain one of the linkage codes based on a user selection, and perform the notification with respect to the one of the linkage codes.

4. The settlement system according to claim 3, wherein the user management server is configured to cause the user terminal to display a list corresponding to the plurality of linkage codes for the user selection.

5. The settlement system according to claim 4, wherein the user management server is configured to:
store the plurality of linkage codes in association with the user code and a store code of the store, and one or more linkage codes in association with the user code and a store code of another store, and
receive the store code along with the user code from the register machine, wherein the list corresponds to the plurality of linkage codes associated with the store code, and not to the one or more linkage codes.

6. The settlement system according to claim 4, wherein the user management server is further configured to change an order of listing in the list based on a use history of the plurality of linkage codes.

7. The settlement system according to claim 2, wherein
the user management server is configured to cause the user terminal to display a representation of the identification code, and
the register machine performs the operation to obtain the identification code from the representation displayed by the user terminal.

8. A method for carrying out settlement with a settlement system including a register machine configured to perform an operation for settlement of a transaction with a user at a store and a user management server, the method comprising:
storing, by the user management server, a linkage code in association with a user code of the user, the linkage code identifying a credit card of the user and being different from a credit code thereof;
performing, by the register machine, an operation to obtain the user code;
obtaining, by the user management server, the linkage code associated with the user code obtained by the register machine;
performing, by the user management server, a notification of the obtained linkage code to a credit card processing server;
receiving, by the user management server, an identification code having an expiration time, that is sent from the credit card processing server in response to the notification;
sending, by the user management server, the received identification code to a user terminal of the user, the identification code being different from the credit code and the linkage code;
performing, by the register machine, an operation to obtain the identification code from the user terminal; and
send, by the register machine, a request for a credit card settlement using the obtained identification code to the credit card processing server.

9. The method according to claim 8, wherein
a plurality of linkage codes is stored in association with the user code, each linkage code identifying a credit card of the user and being different from a credit code thereof,
one of the linkage codes is objected based on a user selection, and
the notification is performed with respect to the one of the linkage codes.

10. The method according to claim 9, further comprising:
causing, by the user management server, the user terminal to display a list corresponding to the plurality of linkage codes for the user selection.

11. The method according to claim 10, wherein
said storing comprises storing the plurality of linkage codes in association with the user code and a store code of the store and one or more linkage codes in association with the user code and a store code of another store,
the method further comprises receiving, by the user management server, the store code along with the user code from the register machine, and
the list corresponds to the plurality of linkage codes associated with the store code, and not to the one or more linkage codes.

12. The method according to claim 10, further comprising:
changing, by the user management server, an order of listing in the list based on a use history of the plurality of linkage codes.

13. The method according to claim 8, further comprising:
causing, by the user management server, the user terminal to display a representation of the identification code,
wherein the identification code is obtained from the representation displayed by the user terminal.

14. A user management server configured to communicate with a credit card processing server, a user terminal, and a register machine configured to perform an operation for settlement of a transaction with a user at a store, the user management server comprising:
a network interface;
a storage device configured to a linkage code in association with the user code, the linkage code identifying a credit card of the user and being different from a credit code thereof; and
a processor configured to:
obtain the linkage code associated with the user code obtained by the register machine, and control the network interface to perform a notification of the obtained linkage code to the credit card processing server, and
receive an identification code having an expiration time, that is sent from the credit card processing server in response to the notification, and control the network interface to send the received identification code to a user terminal of the user, the identification code being different from the credit code and the linkage code.

15. The user management server according to claim 14, wherein
the storage device is configured to store a plurality of linkage codes in association with the user code, each linkage code identifying a credit card of the user and being different from a credit code thereof, and
the processor is configured to obtain one of the linkage codes based on a user selection on the user terminal, and control the network interface to perform the notification with respect to the one of the linkage codes.

16. The user management server according to claim 15, wherein the processor is configured to cause the user terminal to display a list corresponding to the plurality of linkage codes for the user selection.

17. The user management server according to claim 16, wherein
the storage device is configured to store the plurality of linkage codes in association with the user code and a store code of the store, and one or more linkage codes in association with the user code and a store code of another store, and
the processor is configured to receive the store code along with the user code from the register machine, wherein the list corresponds to the plurality of linkage codes associated with the store code, and not to the one or more linkage codes.

18. The user management server according to claim 16, wherein the processor is further configured to change an order of listing in the list based on a use history of the plurality of linkage codes.

19. The user management server according to claim 14, wherein the processor is configured to cause the user terminal to display a representation of the identification code, the identification code being obtained by the register machine from the representation displayed by the user terminal.
